(19) United States
(12) Patent Application Publication
(10) Pub. No.: US 2026/0307494 A1
(43) Pub. Date: Oct. 8, 2026

(54) ONBOARD CUTOFF DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-Shi, Aichi (JP)

(72) Inventors: Kazushi SHIMAMOTO, Yokkaichi-shi, Mie (JP); Hiroyuki TSUJI, Toyota-shi, Aichi (JP); Ryosuke TAKAHASHI, Toyota-shi, Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-Shi, Aichi (JP)

(21) Appl. No.: 19/481,778

(22) PCT Filed: May 23, 2023
(86) PCT No.: PCT/JP2023/019104

§ 371 Date: Nov. 5, 2025

(51) Int. Cl. B60L 3/04; B60L 3/00; B60R 16/03; H02J 9/06

(52) U.S. Cl. CPC B60L 3/04; B60L 3/0046; B60L 3/0061; B60R 16/03; H02J 9/061

(57) ABSTRACT

An onboard cutoff device includes a first cutoff unit, a second cutoff unit, and a control unit. The first cutoff unit is provided between first and second conductive paths, and is switched from a first allowable state in which a flow of a current between the first conductive path side and the second conductive path side is allowed to a first cutoff state in which a flow of a current is cut off. The second cutoff unit is provided between first and third conductive paths, and is switched from a second allowable state in which a flow of a current is allowed to a second cutoff state in which a flow of a current is cut off. During traveling and parking of a vehicle, the control unit maintains the first cutoff unit in the first allowable state, and the second cutoff unit in the second allowable state.

### CROSS-REFERENCE TO RELATED APPLICATIONS

This application is the U.S. national stage of PCT/JP2023/019104 filed on May 23, 2023, the content of which is incorporated herein.

### TECHNICAL FIELD

The present disclosure relates to an onboard cutoff device.

### BACKGROUND

Japanese Patent Application Publication No. 2020-182318 discloses a power supply system in which an important load is provided between a first switch and a second switch, power of a generator and a main power supply is supplied from a first switch side to the important load, and power of a sub battery is supplied from a second switch side.

In the power supply system disclosed in Japanese Patent Application Publication No. 2020-182318, in a normal operation state of a vehicle, the first switch is controlled to be in the ON state, and the second switch is controlled to be in the OFF state. As a result, the power supply system disclosed in Japanese Patent Application Publication No. 2020-182318 cannot charge the sub battery in the normal operation state of the vehicle. For this reason, in the power supply system disclosed in Japanese Patent Application Publication No. 2020-182318, since the sub battery is not sufficiently charged, in a case where power from the alternator and the main power supply is interrupted, there is a concern that power cannot be supplied to the important load without interruption.

The present disclosure has been made in view of the above circumstances, and an object of the present disclosure is to provide an onboard cutoff device capable of reliably supplying power to a load.

### SUMMARY

According to the present disclosure, there is provided an onboard cutoff device used in an in-vehicle system including a generator, a battery, a first load including an important load, a second load having an importance level lower than an importance level of the important load, a first conductive path provided between the generator and the battery, a second conductive path provided closer to the generator than the first conductive path, a third conductive path provided closer to the battery than the first conductive path, a fourth conductive path provided between the first conductive path and the first load, and a fifth conductive path provided between the second conductive path and the second load, the onboard cutoff device including: a first cutoff unit that is provided between the first conductive path and the second conductive path, and is switched from a first allowable state in which a flow of a current between the first conductive path side and the second conductive path side is allowed to a first cutoff state in which at least a flow of a current from the first conductive path side to the second conductive path side is cut off; a second cutoff unit that is provided between the first conductive path and the third conductive path and is switched from a second allowable state in which a flow of a current between the first conductive path side and the third conductive path side is allowed to a second cutoff state in which at least a flow of a current from the first conductive path side to the third conductive path side is cut off; and a control unit that maintains the first cutoff unit in the first allowable state and maintains the second cutoff unit in the second allowable state during traveling and parking of a vehicle.

### Advantageous Effects

According to the present disclosure, it is possible to reliably supply power to a load.

### BRIEF DESCRIPTION OF DRAWINGS

FIG. 1 is a circuit diagram schematically illustrating a configuration of an in-vehicle system according to an embodiment 1.

FIG. 2 is a flowchart illustrating an example of control in an abnormality determination unit according to the embodiment 1.

### DETAILED DESCRIPTION OF PREFERRED EMBODIMENTS

Hereinafter, embodiments of the present disclosure will be listed and described.

In a first aspect, an onboard cutoff device used in an in-vehicle system including a generator, a battery, a first load including an important load, a second load having an importance level lower than an importance level of the important load, a first conductive path provided between the generator and the battery, a second conductive path provided closer to the generator than the first conductive path, a third conductive path provided closer to the battery than the first conductive path, a fourth conductive path provided between the first conductive path and the first load, and a fifth conductive path provided between the second conductive path and the second load, the onboard cutoff device including: a first cutoff unit that is provided between the first conductive path and the second conductive path, and is switched from a first allowable state in which a flow of a current between the first conductive path side and the second conductive path side is allowed to a first cutoff state in which at least a flow of a current from the first conductive path side to the second conductive path side is cut off; a second cutoff unit that is provided between the first conductive path and the third conductive path and is switched from a second allowable state in which a flow of a current between the first conductive path side and the third conductive path side is allowed to a second cutoff state in which at least a flow of a current from the first conductive path side to the third conductive path side is cut off; and a control unit that maintains the first cutoff unit in the first allowable state and maintains the second cutoff unit in the second allowable state during traveling and parking of a vehicle.

In the onboard cutoff device according to the first aspect, the control unit maintains the first allowable state and the second allowable state during traveling and parking of the vehicle, and thus, power can be supplied from the generator to the battery during the generator operates. Thereby, the battery can be reliably charged, and even in a case where the generator fails, power can be supplied from the battery to the important load without interruption.

In a second aspect, the onboard cutoff device according to the first aspect, further including: an abnormality determination unit that determines that power supply from the generator is in a first abnormal state and determines that power supply from the battery is in a second abnormal state, in which the control unit switches the first cutoff unit to the first cutoff state in a case where the abnormality determination unit determines that the power supply is in the first abnormal state, and switches the second cutoff unit to the second cutoff state in a case where the abnormality determination unit determines that the power supply is in the second abnormal state.

In the onboard cutoff device according to (2), it is possible to prevent an abnormality occurring in the generator or the battery from affecting the first load.

In a third aspect, the onboard cutoff device according to the first or the second aspect, in which the in-vehicle system includes a third load that has an importance level lower than the importance level of the important load, and a sixth conductive path that is provided between the third conductive path and the third load.

In the onboard cutoff device according to the third aspect, even in a case where the first cutoff unit and the second cutoff unit are in the cutoff state, power can be constantly supplied from the battery to the third load.

### Embodiment 1

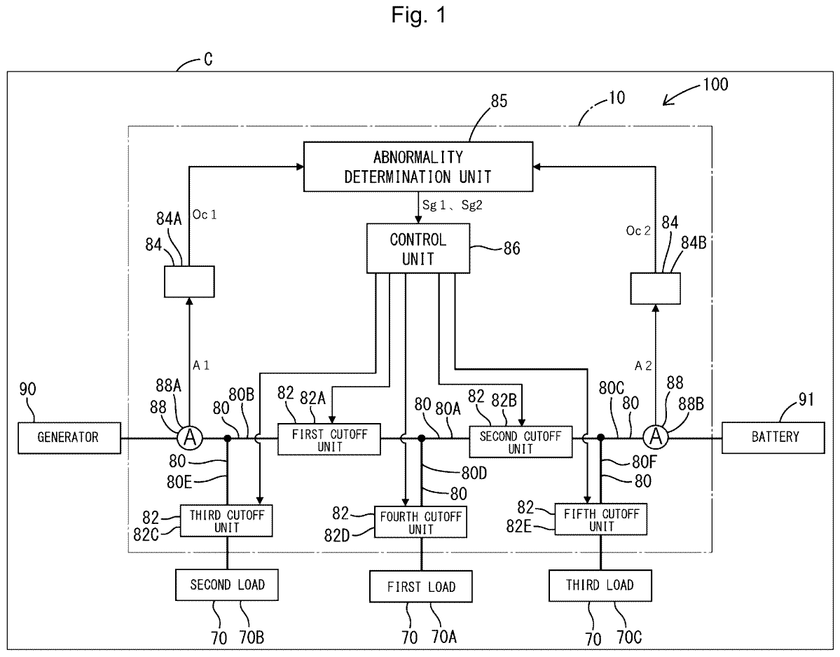

Configuration of In-vehicle System An in-vehicle system 100 illustrated in FIG. 1 is a system mounted on a vehicle C. The in-vehicle system 100 includes a generator 90, a battery 91, loads 70, conductive paths 80, and an onboard cutoff device 10. The in-vehicle system 100 supplies power based on the generator 90 and the battery 91 to the loads 70.

As the generator 90, for example, an alternator is used. The generator 90 supplies power to a second conductive path 80B by operating. A magnitude of an output voltage that the generator 90 outputs during the operation is, for example, slightly larger than 12 V. As the battery 91, for example, a lead storage battery, a lithium ion battery, or the like is used. The battery 91 can output, for example, an output voltage of approximately 12 V.

The loads 70 include a first load 70A, a second load 70B, and a third load 70C. The first load 70A includes an important load having an importance level higher than importance levels of the second load 70B and the third load 70C. The importance level is determined, for example, on the basis of a functional safety level defined in ISO26262. The functional safety level is classified into five stages, starting from the lowest level: QM (Quality Management), ASIL (Automotive Safety Integrity Level)-A, ASIL-B, ASIL-C, and ASIL-D. A load to which a higher functional safety level is assigned is set as a load having a higher importance level. In the present embodiment, a load to which ASIL (that is, ASIL-A to ASIL-D) is assigned is included in the first load 70A. The first load 70A is, for example, an electronic control unit (ECU) of an electric brake device, an ECU of a shift-by-wire device, an ECU of a door lock device, a display device, an ECU of an airbag device, a data communication module (DCM), or the like.

The second load 70B is a load having an importance level lower than the importance level of the first load 70A. The second load 70B is a load that does not affect the safety of the vehicle C even in a case where the second load 70B does not operate during traveling of the vehicle C, and includes, for example, a seat heater, a USB power supply, and the like.

The third load 70C is a load having an importance level lower than the importance level of the first load 70A. The third load 70C is a load that does not affect the safety of the vehicle C even in a case where the third load 70C does not operate during traveling of the vehicle C. The third load 70C is a load through which it is preferable that current flows during parking of the vehicle C, and corresponds to, for example, a memory included in various ECUs and navigation systems. In addition, a load through which a large inrush current flows is also included in the third load 70C.

The conductive paths 80 include a first conductive path 80A, a second conductive path 80B, a third conductive path 80C, a fourth conductive path 80D, a fifth conductive path 80E, and a sixth conductive path 80F. The first conductive path 80A is provided between the generator 90 and the battery 91. The second conductive path 80B is provided closer to the generator 90 than the first conductive path 80A, and is electrically connected to the generator 90. The third conductive path 80C is provided closer to the battery 91 than the first conductive path 80A, and is electrically connected to the battery 91. The fourth conductive path 80D is provided between the first conductive path 80A and the first load 70A. The fifth conductive path 80E is provided between the second conductive path 80B and the second load 70B. The sixth conductive path 80F is provided between the third conductive path 80C and the third load 70C.

In the present disclosure, “electrically connected” is desirably a configuration in which connection targets are connected to each other in a mutually conductive state (a state in which current is allowed to flow) such that potentials of both connection targets are equal. However, the present disclosure is not limited to this configuration. For example, “electrically connected” may be a configuration in which both connection targets are connected to each other in a conductive state while an electric component is interposed between both connection targets.

### Configuration of Onboard Cutoff Device

The onboard cutoff device 10 includes cutoff units 82, current detection units 88, overcurrent detection units 84, an abnormality determination unit 85, and a control unit 86.

The cutoff units 82 include a first cutoff unit 82A, a second cutoff unit 82B, a third cutoff unit 82C, a fourth cutoff unit 82D, and a fifth cutoff unit 82E. The first cutoff unit 82A, the second cutoff unit 82B, the third cutoff unit 82C, the fourth cutoff unit 82D, and the fifth cutoff unit 82E are each configured using one switching element, such as a field effect transistor (FET), for example. The third cutoff unit 82C, the fourth cutoff unit 82D, and the fifth cutoff unit 82E are each configured using, for example, an FET or a thermal fuse (mechanical fuse).

The first cutoff unit 82A is provided between the first conductive path 80A and the second conductive path 80B. For example, the first cutoff unit 82A includes a body diode (not illustrated). A cathode of the body diode of the first cutoff unit 82A is electrically connected to the first conductive path 80A, and an anode of the body diode of the first cutoff unit 82A is electrically connected to the second conductive path 80B. The first cutoff unit 82A is switched from a first allowable state, which is an ON state in which a flow of a current between the first conductive path 80A side and the second conductive path 80B side is allowed, to a first cutoff state, which is an OFF state in which a flow of a current from the first conductive path 80A side to the second conductive path 80B side is cut off. In the first cutoff state, the first cutoff unit 82A allows a flow of a current from the second conductive path 80B side to the first conductive path 80A side by the body diode.

The second cutoff unit 82B is provided between the first conductive path 80A and the third conductive path 80C. For example, the second cutoff unit 82B includes a body diode (not illustrated). A cathode of the body diode of the second cutoff unit 82B is electrically connected to the first conductive path 80A, and an anode of the body diode of the second cutoff unit 82B is electrically connected to the third conductive path 80C. The second cutoff unit 82B is switched from a second allowable state, which is an ON state in which a flow of a current between the first conductive path 80A side and the third conductive path 80C side is allowed, to a second cutoff state, which is an OFF state in which a flow of a current from the first conductive path 80A side to the third conductive path 80C side is cut off. In the second cutoff state, the second cutoff unit 82B allows a flow of a current from the third conductive path 80C side to the first conductive path 80A side by the body diode.

The third cutoff unit 82C is provided on the fifth conductive path 80E. The third cutoff unit 82C is switched from an ON state in which conduction between the second conductive path 80B and the second load 70B is allowed to an OFF state in which the conduction is cut off.

The fourth cutoff unit 82D is provided on the fourth conductive path 80D. The fourth cutoff unit 82D is switched from an ON state in which conduction between the first conductive path 80A and the first load 70A is allowed to an OFF state in which the conduction is cut off.

The fifth cutoff unit 82E is provided on the sixth conductive path 80F. The fifth cutoff unit 82E is switched from an ON state in which conduction between the third conductive path 80C and the third load 70C is allowed to an OFF state in which the conduction is cut off.

The current detection units 88 include a first current detection unit 88A and a second current detection unit 88B. The first current detection unit 88A is provided on the second conductive path 80B. The first current detection unit 88A can detect a current flowing through the second conductive path 80B and a direction in which the current flows in the second conductive path 80B. The first current detection unit 88A is configured by a known current detection circuit using, for example, a current transformer or a shunt resistor. The first current detection unit 88A outputs a signal A1 capable of specifying a magnitude and a direction of the detected current (hereinafter, also simply referred to as a signal A1).

The second current detection unit 88B is provided on the third conductive path 80C. The second current detection unit 88B can detect a current flowing through the third conductive path 80C and a direction in which the current flows in the third conductive path 80C. The second current detection unit 88B is configured by a known current detection circuit similar to the first current detection unit 88A. The second current detection unit 88B outputs a signal A2 capable of specifying a magnitude and a direction of the detected current (hereinafter, also simply referred to as a signal A2).

The overcurrent detection units 84 include a first overcurrent detection unit 84A and a second overcurrent detection unit 84B. The first overcurrent detection unit 84A receives the signal A1 from the first current detection unit 88A. The first overcurrent detection unit 84A is configured to be able to compare the signal A1 with a first current threshold value and output an overcurrent signal Oc1 indicating an overcurrent state in a case where the signal A1 is larger than the first current threshold value. For example, the first current threshold value is set to a value larger than a maximum value of the current flowing through the second conductive path 80B during traveling of the vehicle. For example, a comparator is used for the first overcurrent detection unit 84A.

The second overcurrent detection unit 84B receives the signal A2 from the second current detection unit 88B. The second overcurrent detection unit 84B is configured to be able to compare the signal A2 with a second current threshold value and output an overcurrent signal 0c2 indicating an overcurrent state in a case where the signal A2 is larger than the second current threshold value. For example, the second current threshold value is set to a value larger than a maximum value of the current flowing through the third conductive path 80C during traveling of the vehicle. For example, a comparator is used for the second overcurrent detection unit 84B.

The abnormality determination unit 85 is configured by, for example, a micro controller unit (MCU). The abnormality determination unit 85 is configured to receive the overcurrent signal Oc1 from the first overcurrent detection unit 84A and receive the overcurrent signal Oc2 from the second overcurrent detection unit 84B. The abnormality determination unit 85 determines whether or not the generator 90 is in a ground fault state or whether or not the battery 91 is in a ground fault state, on the basis of the input of the overcurrent signal Oc1 or the overcurrent signal Oc2.

In a case where it is determined that the generator 90 is in the ground fault state (a first abnormal state in which power is not supplied from the generator 90), the abnormality determination unit 85 outputs an abnormality signal Sg1 indicating the first abnormal state. The abnormality determination unit 85 is configured to be able to output an abnormality signal Sg2 indicating the second abnormal state in a case where it is determined that that the battery 91 is in the ground fault state (a second abnormal state in which power is not supplied from the battery 91).

The control unit 86 is configured by, for example, a micro controller unit (MCU). During traveling and parking of the vehicle C, the control unit 86 maintains the first cutoff unit 82A in the first allowable state, and maintains the second cutoff unit 82B in the second allowable state. The control unit 86 maintains the third cutoff unit 82C, the fourth cutoff unit 82D, and the fifth cutoff unit 82E in the ON state during traveling and parking of the vehicle C. The control unit 86 is configured to be able to receive the abnormality signal Sg1 and the abnormality signal Sg2 from the abnormality determination unit 85. The control unit 86 can perform, on the basis of these signals (Sg1, Sg2), control to switch the first cutoff unit 82A from the first allowable state to the first cutoff state and switch the second cutoff unit 82B from the second allowable state to the second cutoff state. The control unit 86 can also perform, on the basis of these signals (Sg1, Sg2), control to switch the third cutoff unit 82C, the fourth cutoff unit 82D, and the fifth cutoff unit 82E from the ON state to the OFF state.

### Example of Operation of Onboard Cutoff Device

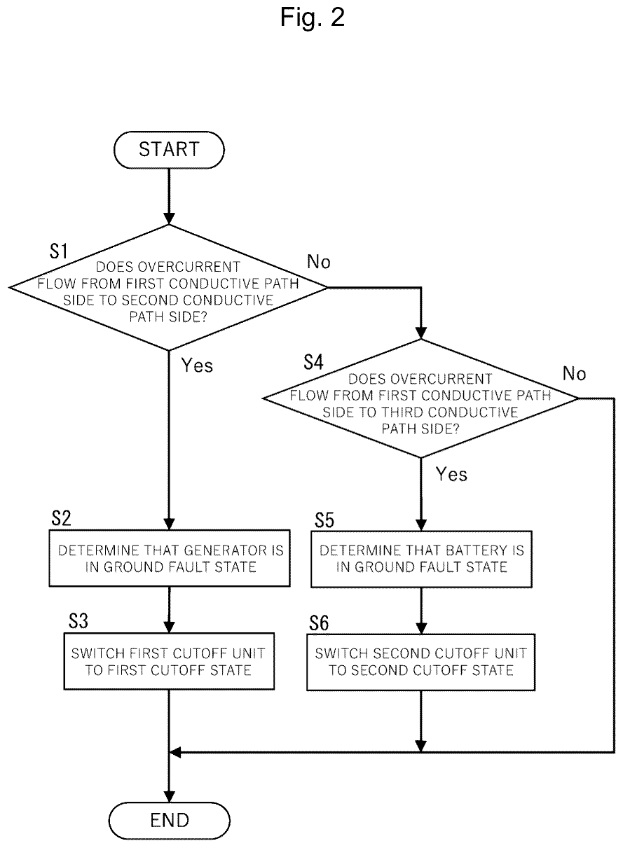

Next, an example f an operation of the onboard cutoff device 10 will be described with reference to FIG. 2. For example, during traveling and parking of the vehicle C on which the in-vehicle system 100 is mounted, the control unit 86 performs control of maintaining the first cutoff unit 82A in the first allowable state and maintaining the second cutoff unit 82B in the second allowable state. At the same time, the control unit 86 performs control of maintaining each of the third cutoff unit 82C, the fourth cutoff unit 82D, and the fifth cutoff unit 82E in the ON state. The onboard cutoff device 10 periodically monitors the current (signal A1) flowing through the second conductive path 80B and the current (flowing through the third conductive path 80C during traveling and parking of the vehicle C. The periodic monitoring corresponds to repeatedly executing the flowchart of FIG. 2 at a predetermined interval.

First, in step S1, the abnormality determination unit 85 determines whether or not an overcurrent flows from the first conductive path 80A side to the second conductive path 80B side. Specifically, the first overcurrent detection unit 84A outputs the overcurrent signal Oc1 to the abnormality determination unit 85 in a case where the signal A1 is larger than the first current threshold value. In step S1, in a case where the abnormality determination unit 85 determines that an overcurrent flows from the first conductive path 80A side to the second conductive path 80B side (Yes in step S1), the process proceeds to step S2.

In a case where the process proceeds to step S2, the abnormality determination unit 85 determines that the generator 90 is in the ground fault state. At the same time, the abnormality determination unit 85 outputs to the control unit 86 the abnormality signal Sg1 indicating that the generator 90 is in the ground fault state.

In a case where the process proceeds to step S3, the control unit 86 switches the first cutoff unit 82A from the first allowable state (ON state) to the first cutoff state (OFF state) on the basis of the input of the abnormality signal Sg1 from the abnormality determination unit 85. That is, in a case where the abnormality determination unit 85 determines that the power supply is in the first abnormal state, the control unit 86 switches the first cutoff unit 82A to the first cutoff state. At this time, the control unit 86 maintains the second cutoff unit 82B in the second allowable state, and maintains the third cutoff unit 82C, the fourth cutoff unit 82D, and the fifth cutoff unit 82E in the ON state. At this time, the control unit 86 may switch the first cutoff unit 82A to the first cutoff state and switch the third cutoff unit 82C to the OFF state. In this way, the process illustrated in FIG. 2 is ended.

In step S1, in a case where the abnormality determination unit 85 determines that an overcurrent does not flow from the first conductive path 80A side to the second conductive path 80B side (No in step S1), the process proceeds to step S4.

In a case where the process proceeds to step S4, the abnormality determination unit 85 determines whether or not an overcurrent flows from the first conductive path 80A side to the third conductive path 80C side. Specifically, the second overcurrent detection unit 84B outputs the overcurrent signal Oc2 to the abnormality determination unit 85 in a case where the signal A2 is larger than the second current threshold value. In step S4, in a case where the abnormality determination unit 85 determines that an overcurrent flows from the first conductive path 80A side to the third conductive path 80C side (Yes in step S4), the process proceeds to step S5.

In a case where the process proceeds to step S5, the abnormality determination unit 85 determines that the battery 91 is in the ground fault state. At the same time, the abnormality determination unit 85 outputs to the control unit 86 the abnormality signal Sg2 indicating that the battery 91 is in the ground fault state.

In a case where the process proceeds to step S6, the control unit 86 switches the second cutoff unit 82B from the second allowable state (ON state) to the second cutoff state (OFF state) on the basis of the input of the abnormality signal Sg2 from the abnormality determination unit 85. That is, in a case where the abnormality determination unit 85 determines that the power supply is in the second abnormal state, the control unit 86 switches the second cutoff unit 82B to the second cutoff state. At this time, the control unit 86 maintains the first cutoff unit 82A in the first allowable state, and maintains the third cutoff unit 82C, the fourth cutoff unit 82D, and the fifth cutoff unit 82E in the ON state. At this time, the control unit 86 may switch the second cutoff unit 82B to the second cutoff state and switch the fifth cutoff unit 82E to the OFF state. In this way, the process illustrated in FIG. 2 is ended.

In step S4, in a case where the abnormality determination unit 85 determines that an overcurrent does not flow from the first conductive path 80A side to the third conductive path 80C side (No in step S4), the process illustrated in FIG. 2 is ended, and the process illustrated in FIG. 2 is executed again.

Next, effects of this configuration will be exemplified.

The onboard cutoff device 10 is used in the in-vehicle system 100 including the generator 90, the battery 91, the first load 70A including an important load, the second load 70B, the first conductive path 80A, the second conductive path 80B, the third conductive path 80C, the fourth conductive path 80D, and the fifth conductive path 80E. The second load 70B has an importance level lower than an importance level of the important load included in the first load 70A. The first conductive path 80A is provided between the generator 90 and the battery 91. The second conductive path 80B is provided closer to the generator 90 than the first conductive path 80A. The third conductive path 80C is provided closer to the battery 91 than the first conductive path 80A. The fourth conductive path 80D is provided between the first conductive path 80A and the first load 70A. The fifth conductive path 80E is provided between the second conductive path 80B and the second load 70B. The onboard cutoff device 10 includes the first cutoff unit 82A, the second cutoff unit 82B, and the control unit 86. The first cutoff unit 82A is provided between the first conductive path 80A and the second conductive path 80B, and is switched from the first allowable state in which a flow of a current between the first conductive path 80A side and the second conductive path 80B side is allowed to the first cutoff state in which a flow of a current from the first conductive path 80A side to the second conductive path 80B side is cut off. The second cutoff unit 82B is provided between the first conductive path 80A and the third conductive path 80C, and is switched from the second allowable state in which a flow of a current between the first conductive path 80A side and the third conductive path 80C side is allowed to the second cutoff state in which a flow of a current from the first conductive path 80A side to the third conductive path 80C side is cut off. During traveling and parking of the vehicle C, the control unit 86 maintains the first cutoff unit 82A in the first allowable state, and maintains the second cutoff unit 82B in the second allowable state.

According to this configuration, the control unit 86 maintains the first allowable state and the second allowable state during traveling and parking of the vehicle C, and thus, power can be supplied from the generator 90 to the battery 91 during the generator 90 operates. Thereby, the battery 91 can be reliably charged, and even in a case where the generator 90 fails, power can be supplied from the battery 91 to the first load 70A (important load) without interruption.

The onboard cutoff device 10 includes the abnormality determination unit 85 that determines that the power supply is in a first abnormal state in which power is not supplied from the generator 90 and determines that the power supply is in a second abnormal state in which power is not supplied from the battery 91. In a case where the abnormality determination unit 85 determines that the power supply is in the first abnormal state, the control unit 86 switches the first cutoff unit 82A to the first cutoff state. In a case where the abnormality determination unit 85 determines that the power supply is in the second abnormal state, the control unit 86 switches the second cutoff unit 82B to the second cutoff state. According to this configuration, it is possible to prevent an abnormality occurring in the generator 90 or the battery 91 from affecting the first load 70A.

The in-vehicle system 100 includes the third load 70C having an importance level lower than the importance level of the important load included in the first load 70A, and the sixth conductive path 80F provided between the third conductive path 80C and the third load 70C. According to this configuration, even in a case where the first cutoff unit 82A and the second cutoff unit 82B are in the first cutoff state and the second cutoff state, power can be constantly supplied from the battery 91 to the third load 70C.

### Other Embodiments

It should be considered that the embodiment disclosed herein is an example in all respects and is not restrictive. The scope of the present disclosure is not limited to the embodiment disclosed herein, is defined by the claims, and is intended to include all modifications within the meaning and the scope equivalent to the claims.

In each of the above embodiments, the importance level of the load is determined on the basis of the functional safety level defined in ISO26262, but another configuration may be used. For example, the importance level of the load may be determined on the basis of another rule. Further, in the above embodiment, the important load is a load to which ASIL-A to ASIL-D are assigned, but another configuration may be used. For example, the important load may be a load to which ASIL-B to ASIL-D are assigned, may be a load to which ASIL-C to ASIL-D are assigned, or may be a load to which only ASIL-D is assigned.

Unlike each of the above embodiments, the control unit and the abnormality determination unit may be configured by one MCU. In addition, the overcurrent detection unit may be configured by one MCU together with the control unit and the abnormality determination unit. In addition, the control unit and the abnormality determination unit may be configured by a plurality of hardware circuits other than the MCU.

Unlike each of the above embodiments, a pair of FETS may be used for each cutoff unit. Specifically, the pair of FETs are disposed such that anodes or cathodes of the body diodes of the FETs face each other. Thereby, in the first cutoff state, the first cutoff unit cuts off a flow of a current between the first conductive path and the second conductive path. Further, in the second cutoff state, the second cutoff unit cuts off a flow of a current between the first conductive path and the third conductive path.

Unlike the above embodiment, the first current threshold value and the second current threshold value may be the same value.

Unlike the above embodiment, a potential detection unit that detects a potential may be provided on each of the second conductive path and the third conductive path instead of the current detection unit, and a low potential detection unit that determines whether or not the potential is decreased on each of the second conductive path and the third conductive path on the basis of a signal output from the potential detection unit may be provided instead of the overcurrent detection unit. In addition, the abnormality determination unit may determine whether or not the generator or the battery is in the ground fault state based on whether or not a low potential signal is input from the low potential detection unit. Further, the abnormality detection unit may determine whether or not the generator or the battery is in an open state on the basis of the low potential signal from the low potential detection unit.

Unlike the above embodiment, the third load, the sixth conductive path, and the fifth cutoff unit may not be provided.

Unlike the above embodiment, a thermal fuse (mechanical fuse) may be used for the third cutoff unit, the fourth cutoff unit, and the fifth cutoff unit.

1. An onboard cutoff device used in an in-vehicle system including a generator, a battery, a first load including an important load, a second load having an importance level lower than an importance level of the important load, a first conductive path provided between the generator and the battery, a second conductive path provided closer to the generator than the first conductive path, a third conductive path provided closer to the battery than the first conductive path, a fourth conductive path provided between the first conductive path and the first load, and a fifth conductive path provided between the second conductive path and the second load, the onboard cutoff device comprising:
a first cutoff unit that is provided between the first conductive path and the second conductive path, and is switched from a first allowable state in which a flow of a current between the first conductive path side and the second conductive path side is allowed to a first cutoff state in which at least a flow of a current from the first conductive path side to the second conductive path side is cut off;
a second cutoff unit that is provided between the first conductive path and the third conductive path and is switched from a second allowable state in which a flow of a current between the first conductive path side and the third conductive path side is allowed to a second cutoff state in which at least a flow of a current from the first conductive path side to the third conductive path side is cut off; and
a control unit that maintains the first cutoff unit in the first allowable state and maintains the second cutoff unit in the second allowable state during traveling and parking of a vehicle.

2. The onboard cutoff device according to claim 1, further including;
an abnormality determination unit that determines that power supply from the generator is in a first abnormal state and determines that power supply from the battery is in a second abnormal state,
wherein the control unit switches the first cutoff unit to the first cutoff state in a case where the abnormality determination unit determines that the power supply is in the first abnormal state, and switches the second cutoff unit to the second cutoff state in a case where the abnormality determination unit determines that the power supply is in the second abnormal state.

3. The onboard cutoff device according to claim 1, wherein
the in-vehicle system includes
a third load that has an importance level lower than the importance level of the important load, and
a sixth conductive path that is provided between the third conductive path and the third load.
